(19) United States
(12) Patent Application Publication
(10) Pub. No.: US 2008/0120142 A1
(43) Pub. Date: May 22, 2008

(54) CASE MANAGEMENT FOR IMAGE-BASED TRAINING, DECISION SUPPORT, AND CONSULTATION

(75) Inventor: Rex Jakobovits, Seattle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: VIVALOG LLC, Seattle, WA (US)

(21) Appl. No.: 11/943,355

(22) Filed: Nov. 20, 2007

Related U.S. Application Data
(60) Provisional application No. 60/860,122, filed on Nov. 20, 2006.

(51) Int. Cl. G06Q 50/00

(52) U.S. Cl. 705/3

(57) ABSTRACT

Methods, apparatuses, and articles for medical case management are described herein. In various embodiments, a server receives a plurality of medically-related documents being associated with a medical case. The server may organize the documents into a case portfolio for distribution to a client for interactive viewing and editing of the documents, the organizing including integrating with the case portfolio client-side logic for facilitating the interactive viewing and editing. In various embodiments, the client may provide an interactive element to facilitate a user of a client in entering medical information to associate with a case portfolio. The client device may retrieve and manifest medical information suggestions in response to entered medical information. In some embodiments, the client may facilitate the user in reviewing the case portfolios to meet certification and/or continuing education requirements. The client may also facilitate a user in engaging in a social collaboration associated with a case portfolio.

### RELATED APPLICATIONS

The present non-provisional application claims priority to provisional application No. 60/860,122, entitled “Methods and Systems to Accommodate Decision Support and Reference Case Management for Diagnostic Imaging”, filed Nov. 20, 2006.

### FIELD OF THE INVENTION

Embodiments of this invention relate to tools, methods and systems for managing medical images and associated text and data, and more specifically, to the creation and use of medical image knowledge bases for decision support, reference, training, consultation, and collaboration.

### BACKGROUND

Clinicians who interpret images make fewer errors when they are able to consult reference images and reference texts. When encountering challenging cases, clinicians frequently turn to textbooks or hunt for reference material on the web. However, the pressure of heavy workloads makes it infeasible for clinicians to consult reference material as often as they would like, as it takes a significant amount of searching to find good examples. Ideally, reference material takes the form of full diagnostic quality exams of known diagnoses, with key images identified and annotated. However, cases in textbooks and online often have only a few static images, usually too low resolution to be considered ideal for diagnosis. Hospital imaging systems and PACS often contain the images that the clinician needs for decision support, but the limited nature of existing retrieval interfaces makes it hard for clinicians to find the right studies.

### SUMMARY OF INVENTION

Embodiments of the invention provide clinicians with searchable repositories of reference cases for consulting, augmenting, training and just-in-time reference for decision-support at the point of care. In various embodiments, the consultation and augmentation may be interactive and/or web-based. Embodiments allow clinicians to add to a repository as part of their daily practice without disrupting their workflow, including techniques to efficiently tag or annotate medical images, series, exams, and subjects with diagnostic information, text, graphical annotations, and keywords, either directly from their existing medical imaging software (PACS, etc), or via a separate interface. In some embodiments, the system can automatically integrate the resulting local content with additional relevant reference content, including differentials, descriptions of findings, cases from third party institutions, and additional illustrative images. Embodiments provide an interface for rapidly scanning through large collections of candidate images from multiple patients, and comparing these images side-by-side to a subject being diagnosed. Embodiments may provide clinicians control over editing, sharing, retrieving, and interacting with the content from any browser.

In various embodiments, the system may include a server capable of receiving, from a plurality of medical-services-related sources, a plurality of medically-related documents of a plurality of heterogeneous document types, the plurality of documents being associated with a medical case. The server may further selectively organize the received documents into one or more case portfolios for selective distribution to one or more client devices remotely disposed from the server and for corresponding interactive viewing and editing of the documents of the distributed case portfolios on the client device, the organizing including integrating with each of the case portfolios client-side logic for facilitating the interactive viewing and editing on a client device.

In some embodiments, the system may include a client device capable of providing an interactive element to facilitate a user of a client device in entering medical information to associate with a document of a case portfolio having a plurality of documents of heterogeneous document types and of receiving medical information entered by the user through the interactive element. In response to the receiving, the client device may retrieve one or more medical information suggestions related to the entered medical information based at least in part on the entered medical information and on a medical context associated with the case portfolio. Further, the client device may manifest the retrieved one or more medical information suggestions to the user to facilitate the user in selecting at least one of the medical information suggestions to associate with the case portfolio, to complement, augment or expand on the entered medical information.

In various embodiments, the client device may also or instead facilitate a user of the client device in meeting medically related certification or continuing education requirements, the facilitating including manifesting to the user one or more case portfolios and tracking a number of case portfolios viewed or an amount of time spent viewing the one or more case portfolios, each of the case portfolio having a plurality of medically related documents. Also, in such embodiments, the client device may provide the user with a report including a plurality of details or metrics, the details or metrics assembled based at least partially on said tracking.

In various embodiments, the client device may also or instead receive a case portfolio having a plurality of documents of heterogeneous document types, including medical information, and client-side logic to enable social collaboration. The client device may then facilitate a user of the client device in engaging in a social collaboration associated with the medical information.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of various embodiments of the present invention;

FIG. 2 illustrates a flowchart view of selected server operations, in accordance with various embodiments;

FIG. 3 illustrates a first flowchart view of selected client device operations, in accordance with various embodiments;

FIG. 4 illustrates a second flowchart view of selected client device operations, in accordance with various embodiments;

FIG. 5 illustrates a third flowchart view of selected client device operations, in accordance with various embodiments;

FIG. 6 illustrates an exemplary screen shot of a JavaScript-enabled case portfolio, in accordance with various embodiments; and

FIG. 7 illustrates an example computing system suitable for practicing all or selected aspects of the invention.

### DETAILED DESCRIPTION OF EMBODIMENTS OF THE INVENTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

As used herein, the term “interactive viewing” means viewing, managing, and/or annotating a retrieved medical image and/or medical information through, for example, user interactions. Such user interactions include at least one of a brightness or contrast adjustment to a medically-related image of a distributed case portfolio, navigation between images of a subset of images of the distributed case portfolio, a zooming or panning action on the medically related image of the distributed case portfolio, drawing annotations on the medically-related image of the distributed case portfolio, or saving annotations drawn on the medically-related image of the distributed case portfolio. The terms “image” and “medical image” are used interchangeably. Thus, unless the context clearly indicates otherwise, the two terms are to be read as synonyms of each other.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A, B, or (A and B)”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

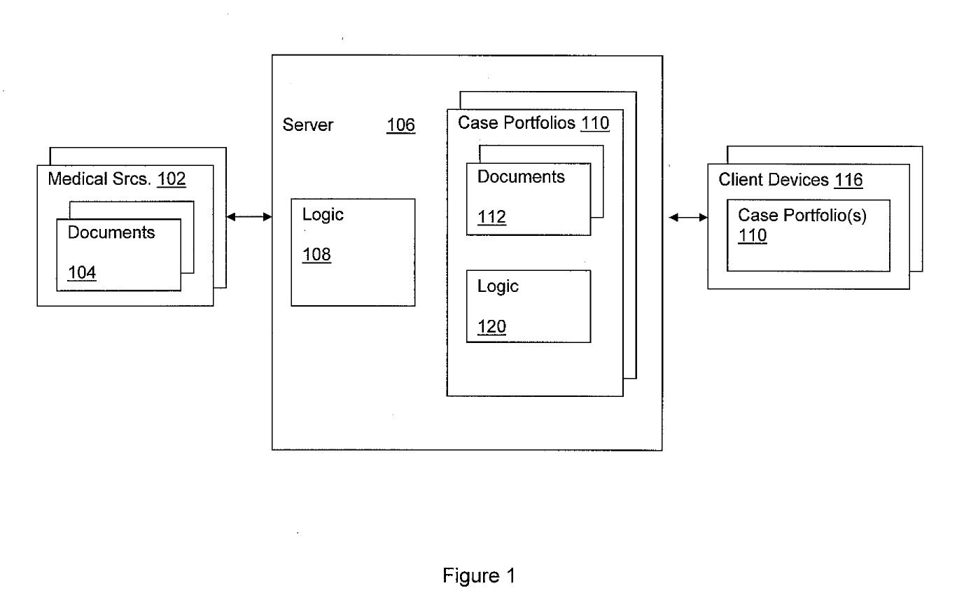

FIG. 1 illustrates an overview of various embodiments of the present invention. As illustrated, a server 106 may receive a plurality of medically-related documents 104 (“documents 104”) of a plurality of heterogeneous document types from a plurality of medical-services-related sources 102 (“medical sources 102”). Upon receiving documents 104, either automatically or in response to a command, server 106 may selectively organize some or all of the documents 104 into one or more case portfolios of a plurality of case portfolios 110 (hereinafter may also be simply referred to as portfolio), each portfolio 110 having a plurality of documents 112, which may be identical to documents 104 or may represent transcoded versions of documents 104. Server 106 may organize the portfolios using logic 108. In some embodiments, in organizing documents 104 into a portfolio 110, logic 108 may compare documents 104 to other case portfolios 110 and may include or reference documents of the other portfolios 110 in the portfolio being organized. Further, logic 108 may include client-side logic 120 in the portfolio 110 being organized to enable recipient client device(s) 116 to facilitate their users in interactive viewing, editing, and/or social collaboration.

In various embodiments, client device 116 may receive case portfolio(s) 110 from server 106. Through logic 120 of portfolios 110, client devices 116 may provide an interactive element to users to enable users to enter medical information to associate with documents 112 of portfolios 110. In some embodiments, in response to the user entering a portion of the medical information, logic 120 may provide the user with suggestions for the medical information.

In further embodiments, logic 120 of portfolios 110 may facilitate users of client devices 116 in meeting education and/or certification requirements.

In some embodiments, logic 120 of portfolios 110 may facilitate users of client devices 116 in engaging in a social collaboration associated with the portfolios 110.

In various embodiments, client devices 116 and server 106 may be communicatively coupled by a networking fabric (not shown). Such a networking fabric may be any known in the art, such as a LAN, a WAN (public or private), and/or the Internet, and may be either partially or entirely wired and/or wireless.

In various embodiments, client devices 116 and server 106 may each be one or more of any sort of computing device known in the art, except for logic 108, portfolios 110, documents 112, logic 120, and other logic and data adapted to perform the operations described more fully herein. Client devices 116 and/or server 106 may each be a personal computer (PC), a workstation, a server, a router, a mainframe, a modular computer within a blade server or high-density server, a personal digital assistant (PDA), an entertainment center, a set-top box or a mobile device. Further, client devices 116 and/or server 106 may each be any single- or multi-processor or processor core central processing unit (CPU) computing system known in the art, except for logic 108, portfolios 110, documents 112, logic 120, and other logic and data adapted to perform the operations described more fully herein. An exemplary single-/multi-processor or processor core user client devices 116 and/or server 106 is illustrated by FIG. 6, and will be described in greater detail below.

As illustrated, medical sources 102 may be any sort of device known in the art that is capable of providing medical information, such as documents 104, including medical images. In some embodiments, the sources 102 include one of a medical device, a computing device, or a removable storage medium. For example, medical sources 102 may include a CT scan device capable of capturing diagnostic images, a third party e-library of medical information, a PACS system for tracking patient cases, and a computer terminal utilized by a clinician to enter information regarding a patient, such as a medical history. In various embodiments, medical sources 102 may include a networking interface to communicate documents 104 to server 106, directly or indirectly. In some embodiments, medical sources 102 may have end users and email applications to enable the end-users to send the documents 104 as attachments to server 106.

In various embodiments, documents 104 may be of a plurality of heterogeneous document types, including at least one of medically-related image(s), diagnostic information, patient medical history, findings, pharmacological information, discussion, or annotations. Medically-related images may include DICOM images having a 16 bit resolution or some other high resolution. In one embodiment, medical source 102 may be a client device 116, and documents 104 may be case portfolio(s) 118 which have been interactively viewed and/or edited by a user. In some embodiments, described further below, documents 104 may comprise a presentation, such as a Microsoft PowerPoint presentation. In various embodiments, documents 104 may comprise attachments to an email sent by a user of a medical source 102 to cause server 106 to automatically generate a case portfolio 110.

As illustrated, server 106 may be any device capable of receiving documents 104 and organizing case portfolios 110. As mentioned, to enable these and other operations, server 106 may include logic 108. Logic 108 may be coded in any sort of programming language known in the art, such as Java, C++, JavaSever Pages, and Active Server Pages. Logic 108 may be compiled instructions executed as a single- or multi-threaded process, or may be an interpreted script executed by, for example, a runtime environment. In various embodiments, server 106 may be a PACS or any other system or device for tracking medical information, modified to include logic 108, case portfolios 110, and documents 112. In some embodiments, server 106 may be a web server offering case portfolios 110 over a networking fabric. Thus, server 106 may store case portfolios 110 and, in various embodiments, a plurality of other network resources for client devices 116.

In some embodiments, logic 108 may transcode some of documents 104, such as the above-mentioned images, upon receipt by server 106, to create documents 112. Documents 112 may have been transcoded by logic 108 for efficient transfer over networking fabric, the transcoded documents 112, comprising images, may have a first image format, such as a JPEG format of a first bit rate lower than a second bit rate of a second image format, such as a DICOM format, of documents 104. In other embodiments, the images of documents 104 may already have the first, lower bit rate. In such embodiments, logic 108 may not transcode those images. In some embodiments, with the exception of some or all of images of documents 104, documents 104 may be identical to documents 112. In other embodiments, logic 108 may convert a first format of documents 104 to a second format of documents 112. For example, documents 104 may include word processor documents, such as Microsoft Word documents, spreadsheets, database query results, and/or PDF documents, and logic 108 may convert documents 104 into documents 112 comprised of Hypertext Markup Language (“HTML”) segments, Extensible Markup Language (“XML”) segments, and/or JavaScript segments.

In some embodiments, logic 108 may organize documents 112 that are related to a single medical case into a case portfolio 110. In other embodiments, logic 108 may also include information and/or documents from other case portfolios 110 determined to be relevant to documents 112 with the documents 112. In one embodiment, logic 108 may determine the other case portfolios 110 to be relevant based on comparisons of one or more keywords, tags, or annotations associated with the other case portfolios 110 with documents 112. In one embodiment, where documents 104 comprise a presentation file, the organizing may comprise extracting information from the presentation file, and including the extracted information in the case portfolio 110 as documents 112. In another embodiment, logic 108 may automatically organize a case portfolio 110 in response to receiving an email including documents 104 as attachments. In some embodiments, in assembling the documents 112 into a case portfolio 110, logic 108 may include client-side logic 120.

In various embodiments, case portfolios 110 may be a web page or any other sort of content provided over a network, such as the Internet. As mentioned above, case portfolios 110 may be organized from documents 112, which may include medical information comprising textual, graphic, video, and/or audio information. Such information may be related to a single case, a series of cases, a diagnosis, or any other medically related topic. For example, as illustrated by FIG. 6 and described below, the medical information may comprise Findings with regard to a case, the findings describing, in part, images.

In various embodiments, as mentioned, case portfolios 110 may include logic 120. In some embodiments, case portfolios 110 may be comprised JavaScript segments, the JavaScript segments comprising at least partially logic 120. In one embodiment, logic 120 of case portfolios 110 may enable a browser of a client device 116 to interactively view and/or edit documents 112 and/or other portions of case portfolios 110. The interactive viewing includes a user interaction, and the user interaction is one of a brightness or contrast adjustment to a medically-related image of a distributed case portfolio, navigation between images of a subset of images of the distributed case portfolio, a zooming or panning action on the medically related image of the distributed case portfolio, drawing annotations on the medically-related image of the distributed case portfolio, or saving annotations drawn on the medically-related image of the distributed case portfolio. Further, the editing includes at least a selected one of adding to, annotating, or deleting information from a document 112 of a distributed case portfolio 110. In one embodiment, the interactive viewing may include asynchronously retrieving images of documents 112 and/or other contents through use of a technique known as Asynchronous JavaScript and XML (“AJAX”). In some embodiments, logic 120 may enable users of client devices 120 to associate medical information with portfolios 110, facilitate users in certification and/or continuing education, and/or facilitate users of client devices 116 in engaging in a social collaboration associated with the portfolios 110, these operations described in greater detail below.

In various embodiments, logic 108 may provide wide range of methods for getting documents 104, such as images: DICOM send, file upload, IHE, MIRC publishing, image prefetching, and email. Each medical source 102, such as a PACS, may offer its own preferred method for exporting images, and logic 108 may support them all.

In various embodiments, as described briefly above, logic 108 may provide the ability to create cases via email. From the PACS workstation, such as medical source 102, users may have a menu option to ‘email selected images’, which may open an email editor with the images attached. The user may also enter text and then press “send”. Server 106 may then receive the email and automatically create a case portfolio 110 in the manner discussed above. Embodiments of the invention may parse the email text to create the case portfolio 100 title, findings, diagnosis, and discussion, and populates the portfolio 110 with properties embedded in the images, such as DICOM properties.

In some embodiments, logic 108 may provide a streamlined case authoring process that uses image prefetching from a predefined prefetch directory, which may be polled continuously for files by server 106. When images are saved to the Prefetch directory, they may automatically be imported into the portfolio 100 being organized by logic 108. Each client device 116 user may have their own destination directory in the prefetch directory. Images saved to a specific user's directory may be added to case portfolios 110 owned by that user.

In some embodiments, logic 108 may provide merging of case portfolios 110. In one embodiment, logic 108 may merge portfolios in response to receiving a selection from a user of a client device 116 of a link labeled “merge cases.” Selection of the link by the user may bring up a list of case portfolios 110 with checkboxes next to each, with instructions “Select cases to merged using checkboxes below, and then press [Merge Selected Cases].” In other embodiments, the user may then submit a form of the currently viewed case portfolio 110 to see a new form listing the case portfolios 110 to be merged, with a radio button next to each, and instructions: “Specify the destination case and press [Merge Cases].” Beneath the submit button may be a checkbox (default=checked) saying “Delete source cases after merge.” When pressing submit, if “delete source cases” is selected, logic 120 may prompt the user with “Are the user sure?” Logic 108 may then perform the merge, organizing a new portfolio 110 in the manner described above, and delete the originals (or not). In various embodiments, merging may result in the destination case portfolio 110 being augmented. For example, logic 108 may add images from the other case portfolios being merged into the destination portfolio 110. If the source case portfolios 110 are being deleted, logic 108 may reuse the CaseImage objects, otherwise logic 108 can copy the images. Also, logic 108 may append values of text fields from all the source case portfolios 110 and separate appended text with newlines. Further, logic 108 may add modalities from source case portfolios 110 to the destination case portfolio 110.

In various embodiments, as briefly described above, logic 108 may allow users of sources 102 to submit cases via presentations. Logic 108 may use win32::ole to parse the contents of the presentation and may create one case portfolio 110 per presentation. Logic may create a case image (document 112) for each image in the presentation. If a slide contains an image and some text, logic 108 may use the text as the caption. If the slide contains multiple images and text, logic 108 may determine which images should get captions or just combine all the text as the caption of one of the images. If a slide contains only text and no images, logic 108 may stick the text in a “discussion” document 112 (discussion may contain concatenated text from multiple slides). In one embodiment, logic 108 may preserve some of the text formatting (bullets, etc) as HTML within the discussion text. In another embodiment, the title of presentation (or text of first slide) may become the title of the case portfolio 110.

In some embodiments, logic 108 may allow users to export their case portfolios 110 as presentations. The conversion may be done on the server 106, and the user of a client device 116 can simply download the presentation file. Logic 108 may automatically extract content from any container (e.g. a zip file), convert the text content and images into a presentation file, and save the new presentation to a default location. Logic 108 may provide a default of one image per slide, or allow a user requesting the presentation to control how many images appear per slide. Logic 108 can include an optional directive which will contain parameters for the user's converter, e.g.:

<display-parameters>

<images-per-page> 2 </images-per-page>

</display-parameters>

Also, logic 108 may resize images if they are too large, so they fit on the slide. The image size may depend on how many images are placed on a slide. Also, logic 108 may decrease font size, if necessary, to fit text on a slide. In another embodiment, a client-side executable, rather than logic 108 will convert case portfolio 110 content into a presentation.

In one embodiment, logic 108 can allow exporting multiple cases at once, either into a single presentation or multiple presentations. For example, logic 108 may handle a zip file that contains multiple XML files. A “table of contents” slide may be created that lists all the cases portfolios 110, then append the output of each portfolio 110 to the presentation.

As illustrated and as previously mentioned, client devices 116 may receive portfolios 110 from server 106, directly or indirectly, via a networking fabric. In various embodiments, client devices 116 may include web browsers, such as JavaScript-enabled browsers, to allow users to interactively view and/or edit case portfolios 110. In some embodiments, logic 120 of a case portfolio 110 may enable a user of a client device 116 to associate medical information with the case portfolio 110. Logic 120 may enable the association by providing an interactive element to facilitate a user of client device 116 in entering medical information to associate with a document 112 of a case portfolio 110. The interactive element may be a text box. Client device 116 may then receive medical information entered by the user through the interactive element. In some embodiments, the medical information may be a truncated partial string of a medical term or phrase.

In various embodiments, the client device 116 may then, in response to said receiving, retrieve one or more medical information suggestions related to the entered medical information based at least in part on the entered medical information and on a medical context associated with the case portfolio 110. In some embodiments, the medical context may be one of a medical examination type and a pathology type associated with a patient and/or medical image referred to in the case portfolio 110. Also, the suggestions may be retrieved by searching a knowledge base including one or more of user-defined lists, common vocabularies, folksonomies, or suggestions by other users. The knowledge base may, in some embodiments, be a database of server 106. Further, the retrieving may be performed in real time after the user started entering the medical information. The client device 116 may then manifest the retrieved one or more medical information suggestions to the user to facilitate the user in selecting at least one of the medical information suggestions to associate with the case portfolio 110, to complement, augment or expand on the entered medical information.

In various embodiments, logic 120 may also or instead facilitate a user of a client device 116 in meeting certification and/or continuing education requirements, the facilitating including manifesting to the user one or more case portfolios 110 and tracking a number of case portfolios 110 viewed and/or an amount of time spent viewing the one or more case portfolios 110. In some embodiments, the tracking may comprise turning on a timer object of logic 120 when the user begins to view one of the case portfolios 110 and turning the timer object off when the user is finished. Further, in various embodiments, the facilitating may further comprise enabling the user to view the one or more case portfolios 110 in a training mode. The training mode may include one or more of quizzes and phased display(s) of the case portfolios 110.

In various embodiments, logic 120 may then provide the user with a report including a plurality of details and/or metrics, the details and/or metrics assembled based at least partially on the tracking. Also, the details and/or metrics may include at least one of the number of case portfolios 110 viewed by the user, a number of case portfolios 110 viewed in a training mode, and a total time accumulated while viewing case portfolios 110. In some embodiments, logic 120 may then assign (or facilitate the assigning of) credits based on the provided report.

In some embodiments, the report may be a Learning Manager (LM) Report which may present, in table form for a specific date range, details such as how many unique case portfolios 110 the user visited, how many of those case portfolios 110 were viewed with training mode on, and how much total time accumulated during active sessions.

In one embodiment, server 106 may allow a privileged user to specify a start date and end date for the report, as well as choose from a popup of preset ranges: [Past Month, Past Year, Entire History]. Various embodiments may allow three global settings for tracking visit time, controlled by the privileged user through server 106: 1) disabled (do not track visit time), 2) always on (always track everyone's visit times), 3) timer-controlled: only track visit time when user explicitly turns on timer. For the third option, some embodiments may provide a “Timer On”/“Timer Off” toggle similar to training mode. To avoid cluttering the screen of users who don't want a timer control, the timer control only appears for users who opt for it by interactively viewing portfolio(s) 110. A Preferences screen may allow users to enable or disable the timer toggle for their account. This enable/disable preference and the timer itself may only appear if the privileged user chooses the global timer-controlled setting.

In some embodiments, logic 120 may further enable users to practice on random case portfolios 110 in unknown mode. A button may retrieve a random case portfolio 110 that the user hasn't seen before. Users may constrain the random case portfolio(s) 110 to specific properties, folders or categories.

Embodiments may further offer a feature in which logic 120 enables users to turn on “training mode” to view case portfolios 110 as unknowns. When training mode is on, abstracts/listings may not reveal a title or diagnosis, and in the case portfolio 110 viewer, case text and captions may be revealed iteratively instead of all at once.

In various embodiments, as mentioned, case portfolios 110 may include quizzes. Logic 120 may then keep track of users' performance when they take the quizzes. In one embodiment, server 106 may allow instructors to lock certain cases as unknowns for specific users until quizzes have been performed.

In some embodiments, a quiz may be a set of questions, each of which may comprise the following attributes: 1) Question sequence number; 2) Question prompt (text); 3) List of answers; 4) Answer sequence number; 5) Answer correctness (correct/incorrect); and 6) Answer explanation (optional text to appear after the user has selected that answer).

Case portfolios 110 with quizzes may be visually identifiable from the case abstract level (e.g. marked with a quiz icon). When Training Mode is turned on, if a case portfolio 110 has a quiz, the training mode navigator (at the top of the case) may prompt user to take the quiz. When the user takes quiz, logic 120 may reload the case portfolio 110 view with the first quiz question appearing under the images (in a section labeled Quiz). The answers may include letters as hyperlinks. If the user clicks on the wrong answer, logic 120 reload the page with text in the quiz section informing the user of the wrong answer (e.g., “Sorry, that's WRONG”). If the answer is right, logic 120 may display a different message in the quiz section informing the user of the correct answer (e.g., “CORRECT!”). When the user has correctly answered all the questions, logic 120 may provide a message such as “Congratulations! You have completed the quiz.” If the training mode is not on, logic 120 may provide a link “Take Quiz?”, appearing at the top of the case, which may turn the training mode on and go directly to the quiz stage.

As mentioned, logic 120 may keep track of which quizzes a user has completed (using a mechanism similar to the visit tracker). If a user has completed a quiz, logic 120 may use a different icon in the case abstract than if the user has not completed a quiz. Also, logic 120 may display the date/time that the quiz was completed by that user.

In some embodiments, different sections of a quiz may be assigned to different stages of training mode (e.g. have one set of questions occur before findings are revealed and another set of questions occur after findings are revealed). In one embodiment, server 106 may allow quiz authors to lock case portfolios 110 so the quiz must be taken before the full case portfolio 110 is revealed. In another embodiment, logic 120 may interleave quiz questions and display of images.

In various embodiments, as mentioned briefly above, logic 120 may allow client device 116 users to view portfolio(s) 110 in a training mode. The training mode may allow the user to view the case portfolios 110 as unknowns, and sequentially reveal case text in stages. For example, in a first mode, the user may view a portfolio 110 as an unknown. Patient demographics and history may be displayed, but the case title and other fields may be withheld. Images may be displayed with no captions. The user can study the images and try to identify the findings. In a second mode, the user may read the findings text and try to predict the diagnosis. If the case portfolio 110 contains annotated images showing the findings, they may appear as well. This stage may be skipped if the portfolio 110 contains no captions or findings text. In a third mode, the entire case portfolio 110 may be displayed, revealing the diagnosis and discussion. Training Mode may be useful for self testing, as well as for conferences, allowing the presenter to control the information displayed to the audience. In some embodiments, training mode may stay on until the user clicks a “Turn Off” element in a controller above a navigation bar of the case portfolio 110 view.

In various embodiments, logic 120 may facilitate a user of the client device 116 in engaging in a social collaboration associated with medical information/documents 112 of case portfolio 110. In some embodiments, facilitating the user in engaging in the social collaboration may comprise facilitating the user in posting a question associated with the medical information. In some embodiments, the logic 120 may then provide the question posting to server 106 to enable server 106 to alert one or more other client devices 116 of the case portfolio 110 and the question posting. In various embodiments, the facilitating may also or instead comprise facilitating the user in answering a question posting associated with the medical information or in rating and/or recommending the case portfolio 110 to other users of a community. In some embodiments, logic 120 may also facilitate the user in providing one or more medical images to a server 106 to enable the server 106 to update the case portfolio 110 with the provided images or to create a new portfolio 110 based on the provided images, in the manner described above.

In various embodiments, logic 120 may provide social-collaborative functionality that allows medical images and related information to become focal points for communication and collaboration within and across departments or other intra or inter organizational entities. Functionality may include being able to see which cases are most popular, tagging cases for quick retrieval using dynamic keyword lists, subscribing to Image Alerts in the form of email notification whenever a new case is created that matches their interests, and case-centric collaborative editing interfaces in which authorized users can easily edit content directly in their web browsers.

In some embodiments, logic 120 may further include functionality for interdisciplinary collaboration and sharing of content across and within departments, and between institutions, or other intra or inter organizational entities.

In some embodiments, logic 120 may further offer a Collaborative Publishing Model, in which users may create, submit, edit, certify, share, and/or annotate case portfolios.

In various embodiments, logic 120 may further offer a wide range of methods for getting images into a case portfolio 110: DICOM send, file upload, IHE, MIRC publishing, image prefetching, and email. Each PACS offers its own preferred method for exporting images, so the system can support them all.

In some embodiments, logic 120 may further offer a feature in which the system enables users to sign up for email alerts. Whenever case portfolios matching their saved search criteria are created or modified, the user may receive an email with a link to the case portfolio(s) 110.

In various embodiments, logic 120 may further offer a feature in which contributors are enabled to solicit comments or assistance through a form element, and other users who have subscribed to alerts will receive notification that a new case portfolio 110 is awaiting their feedback, and they may add comments directly to the case portfolio 110 and/or email the author.

In some embodiments, logic 120 may enable the user to post comments to any case portfolio 110. Comments can be either public (viewed by anyone) or private (viewable by only the comment author). Comments may be useful for leaving searchable notes about a case, leaving feedback for the case author, starting a general discussion, pointing out additional findings, or questioning the validity of the case. Depending on how the system is configured, the owner of a case portfolio 110 may receive an email every time a comment is posted to his case. The rating interface may include a star system, where the rating is sent to the server 106 without requiring the user to click submit, and criteria which have been rated will show up as yellow stars. Once a user turns on the rating form for a case portfolio 110, “rating mode” may be sticky/“on” for the rest of the session, with the rating form appearing at the top of every case portfolio 110. The rating form may have a “hide” link which may turn off the rating mode. User can toggle the rating mode back on by clicking “Rate” in the title bar of any case.

In various embodiments, a full case portfolio 110 view may be provided. Under this view, logic 120 may enable the showing of all rating criteria (including composite average) under “additional details.”

In some embodiments, logic 120 may add the various rating criteria to a “Sort By” element. Logic 120 may include each criterion separately, as well as “Overall Rating”, which may be the composite average.

In various embodiments, logic 120 may further offer a video generation service: sequences of images or cine loops can be added to a case (either via dicom or upload), and they can be turned into streaming videos (e.g. flash) embedded in the case portfolio 110.

Embodiments may further offer, through logic 120, diagnosis-centric case organization integrated with third party evidence-based medicine. Each diagnosis may have its own page, whose content is constructed as a “mashup” from content modules that the institution subscribes to (e.g. acr learning files, digitized reference texts, discussions from other institutions). Differentials may be listed, and each may be a hyperlink to other disease pages and findings pages. Each type of finding may have its own page, with links to all diseases suggested by the finding. The user may be enabled to select a subset of findings to narrow the possible diagnoses. A diagnosis page may list all cases of that diagnosis, which the user can then filter through faceted drill-down (e.g. narrow to specific demographics or anatomic involvement). At each level, the user may be presented with a list of differentiators, which when clicked filter the candidate list according to that differentiator. The differentiators are determined by the attribute space. The user may decide what order to perform the filtering by selecting from the attribute space at each level.

In some embodiments, logic 120 may enable client device 116 users to step through iterative presentation(s) of case portfolios(s) 110 with a convenient interface, similar to VCR controls. The case portfolios(s) 110 may have a presentation mode in which the user simply clicks a centralized “Forward” or “Backward” control, stepping through the case text and full-screened images in a scripted order, thus removing any unnecessary interaction with the individual controls for the cases. The user may click a button to advance or rewind, or may use the scroll wheel or keyboard strokes. An example of an iterative presentation is: show history, show image 1 in fullscreen, show image 1 caption, show image 2 in full screen, show image 2 caption, show findings subsection 1, show image 3 in full screen, show image 3 caption and annotations, show findings subsection 2, show image 4 in full screen, show image 4 caption and annotations, show differentials, show diagnosis, show discussion, show references, show next case. There can be multiple levels of advancing: 1) next minor step (e.g. subpage or reveal caption), 2) medium step (e.g. next text section), or 3) major step (e.g. next case).

This may further be useful for training and conference presentations. Case authors may break text into sub pages, which may be displayed in stages. Breaking text into subpages can be achieved with a “pagebreak” button. Authors can also control when images get displayed (e.g. display always, hide until findings stage, hide until diagnosis is revealed, hide until discussion stage). That control can be achieved via dropdown menus. The dropdown menus can be tied together to avoid inconsistencies and preserve image ordering. For example, if the user specifies that image 3 should be hidden until the Findings stage, then subsequent figures will inherit that specification.

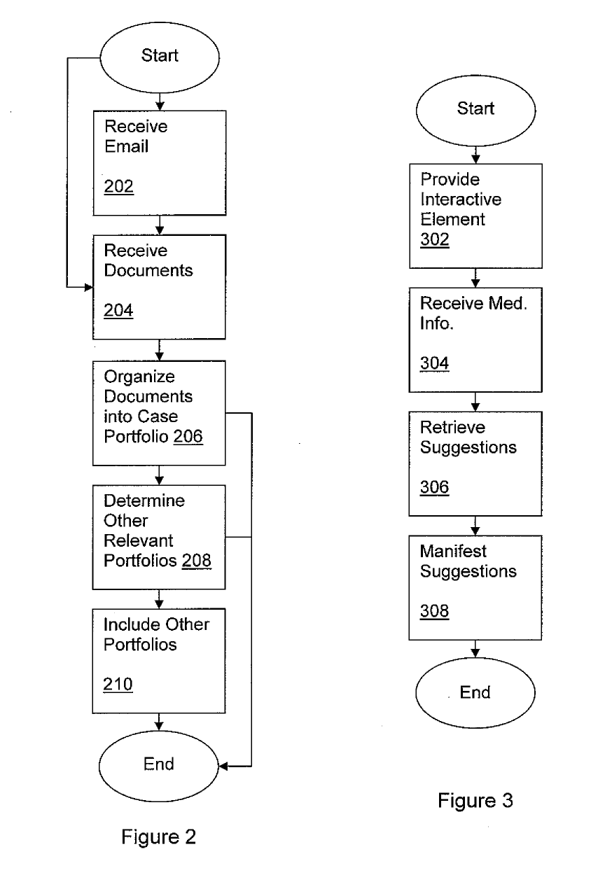

FIG. 2 illustrates a flowchart view of selected server operations, in accordance with various embodiments. As illustrated, a server may receive, from a plurality of medical-services-related sources, a plurality of medically-related documents of a plurality of heterogeneous document types, block 204, the plurality of documents being associated with a medical case. In some embodiments, the plurality of heterogeneous document types may include at least one of medically-related image(s), diagnostic information, patient medical history, findings, pharmacological information, discussion, or annotations. Also, the sources may include one of a medical device, a computing device, or a removable storage medium.

In various embodiments, the server may then selectively organize the received documents into one or more case portfolios for selective distribution to one or more client devices remotely disposed from the server and for corresponding interactive viewing and editing of the documents of the distributed case portfolios on the client device, block 206, the organizing including integrating with each of the case portfolios client-side logic for facilitating the interactive viewing and editing on a client device. In some embodiments, the interactive viewing includes a user interaction, and the user interaction is one of a brightness or contrast adjustment to a medically-related image of a distributed case portfolio, navigation between images of a subset of images of the distributed case portfolio, a zooming or panning action on the medically related image of the distributed case portfolio, drawing annotations on the medically-related image of the distributed case portfolio, or saving annotations drawn on the medically-related image of the distributed case portfolio. Also, the editing includes at least a selected one of adding to, annotating, or deleting information from a document of a distributed case portfolio.

In some embodiments, receiving the documents, block 204, may comprise receiving a presentation file, and organizing, block 206, may comprise extracting information from the presentation file and including the extracted information in the case portfolio.

In various embodiments, the server may automatically performing said receiving, block 204, and said organizing, block 206, in response to receiving an email from the user, block 202, including one or more medical images and/or text, the one or more medical images and/or text comprising the received documents.

As is further shown, the server may then determine one or more other case portfolios to be relevant based on comparisons of one or more keywords, tags, or annotations associated with the other case portfolios with a received document being organized into a case portfolio, block 208. Then, the server may automatically including into the case portfolio, by the server, information and/or documents from one or more other case portfolios determined to be relevant to the received document, block 210.

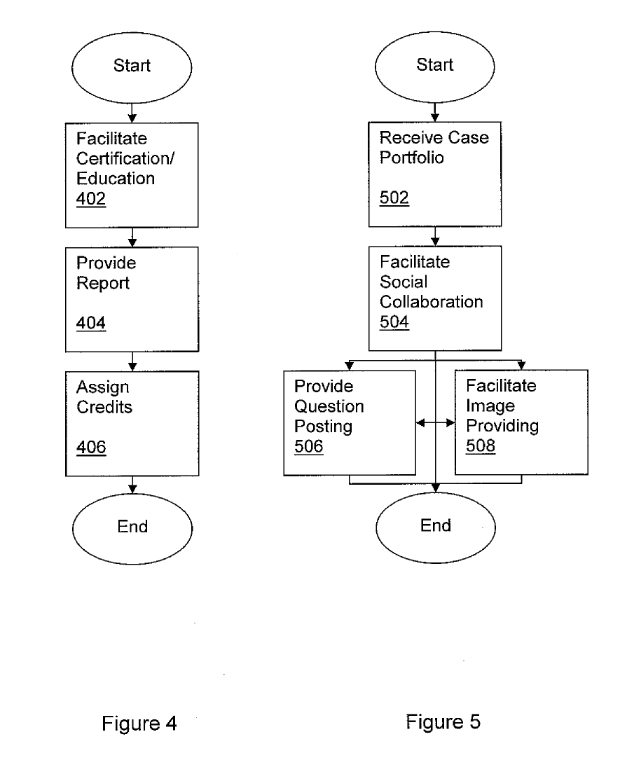

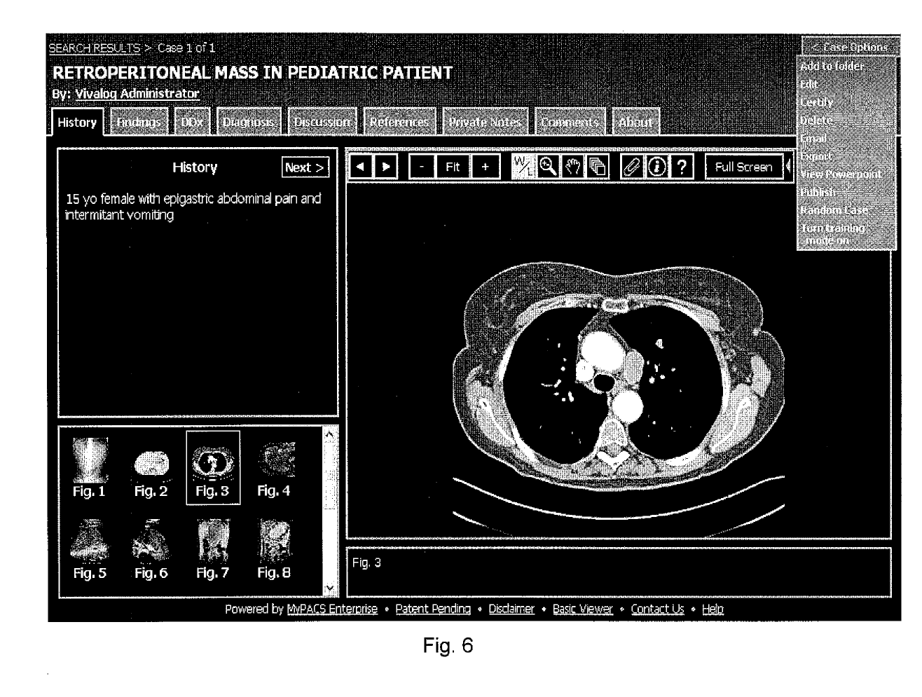

FIG. 3 illustrates a first flowchart view of selected client device operations, in accordance with various embodiments. As illustrated, the client device may provide an interactive element to facilitate a user of a client device in entering medical information to associate with a document of a case portfolio having a plurality of documents of heterogeneous document types, block 302. In some embodiments, the case portfolio may include a plurality of medically-related documents of a plurality of heterogeneous document types, the document types including one or more of medical image(s), diagnostic information, patient medical history, findings, pharmacological information, discussion, or annotations. Also, the interactive element may be a text box. The client device may then receive medical information entered by the user through the interactive element, block 304. In some embodiments, the medical information may be a truncated partial string of a medical term or phrase.

In various embodiments, the client device may then, in response to said receiving, block 304, retrieve one or more medical information suggestions related to the entered medical information based at least in part on the entered medical information and on a medical context associated with the case portfolio, block 306. In some embodiments, the medical context may be one of a medical examination type and a pathology type associated with a patient and/or medical image referred to in the case portfolio. Also, the suggestions may be retrieved by searching a knowledge base including one or more of user-defined lists, common vocabularies, folksonomies, or suggestions by other users. Further, the retrieving, block 306, may be performed in real time after the user started entering the medical information. The client device may then manifest the retrieved one or more medical information suggestions to the user to facilitate the user in selecting at least one of the medical information suggestions to associate with the case portfolio, to complement, augment or expand on the entered medical information, block 308.

FIG. 4 illustrates a second flowchart view of selected client device operations, in accordance with various embodiments. As illustrated, a client device may facilitate a user of the client device in meeting medically related certification or continuing education requirements, block 402, the facilitating including manifesting to the user one or more case portfolios and tracking a number of case portfolios viewed or an amount of time spent viewing the one or more case portfolios, each of the case portfolio having a plurality of medically related documents. In some embodiments, the case portfolios may each includes a plurality of medically-related documents of a plurality of heterogeneous document types, the document types including one or more of medical image(s), diagnostic information, patient medical history, findings, pharmacological information, discussion, or annotations. Also, the tracking comprises turning on a timer when the user begins to view a document of one of the case portfolios and turning the timer off when the user stops viewing documents of the case portfolios. Further, in various embodiments, the facilitating, block 402, may further comprise enabling the user to view the one or more case portfolios in a training mode. The training mode may include one or more of quizzes or phased display(s) of the case portfolios.

In various embodiments, the client device may then provide the user with a report including a plurality of details or metrics, block 404, the details or metrics assembled based at least partially on said tracking. Also, the details or metrics may include at least one of the number of case portfolios viewed by the user, a number of case portfolios viewed in a training mode, and a total time accumulated while viewing case portfolios. In some embodiments, the client device may then assign certification or continuing education requirement related credits based on the provided report, block 406.

FIG. 5 illustrates a third flowchart view of selected client device operations, in accordance with various embodiments. As illustrated, a client device may receive a case portfolio having a plurality of documents of heterogeneous document types, including medical information, and client-side logic to enable social collaboration, block 502. In various embodiments, the client device may then facilitate a user of the client device in engaging in a social collaboration associated with the medical information, block 504. In some embodiments, facilitating the user in engaging in the social collaboration, block 504, may comprise facilitating the user in posting a question associated with the medical information. In some embodiments, the client device may then provide the question posting to a server to enable the server to alert one or more other client devices of the case portfolio and the question posting, block 506. In various embodiments, the facilitating, block 504, may also or instead comprise facilitating the user in answering a question posting associated with the medical information or in rating and/or recommending the case portfolio to other users of a community. In some embodiments, the client device may also facilitate the user in providing one or more medical images to a server to enable the server to update the case portfolio with the provided images or to create a new portfolio based on the provided images, block 508.

FIG. 6 illustrates an exemplary screen shot of a JavaScript-enabled case portfolio 110, in accordance with various embodiments. As illustrated, the portfolio 110 may include an image viewer on the right and display areas dedicated to displaying medical information (such as the displayed “Findings”), a collection of thumbnails of images, graphic controls to enable the above-described interactive viewing, and a series of tabs to enable the tab-based content display discussed above. The images and information of portfolio 110 may correspond to the documents 112 organized into case portfolios 110, by logic 108 of server 106. As described above, portfolio 110 may further include logic 120 to enable a client device 116 user to associate medical information with documents of portfolio 110 or to use portfolio 110 for training or certification purposes.

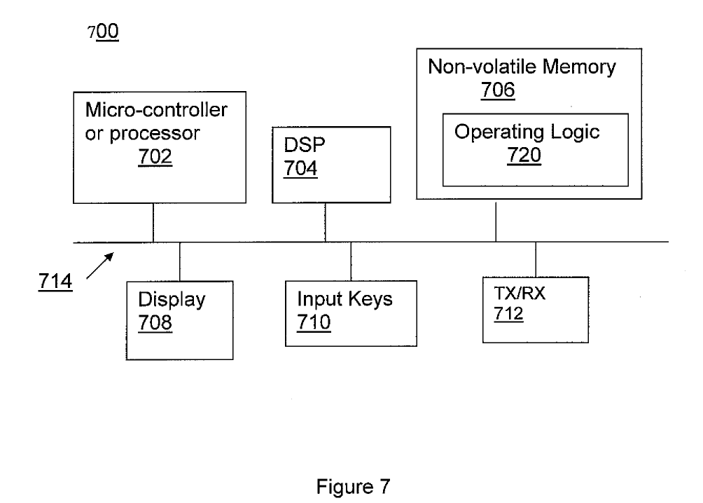

FIG. 7 illustrates an example computing system suitable for practicing all or selected aspects of the embodiments of the invention. As illustrated, in some embodiments, a computing device 700 may include elements found in conventional computing device, such as micro-controller/processor 702, digital signal processor (DSP) 704, non-volatile memory 706, display 708, input keys 710 (such as 12-key pads, select buttons, D-units), and transmit/receive (TX/RX) 712, coupled to each other via bus 714, which may be a single bus or an hierarchy of bridged buses. Further, non-volatile memory 706 may include operating logic 720 adapted to implement in full or in part the earlier described operations for practicing the methods of the various embodiments of the present invention, such as logic 108 and/or logic 120. The implementation may be via any one of a number programming languages, assembly, C, and so forth.

The permanent copy of the programming instructions may be placed into non-volatile memory 706 in the factory, or in the field, through, for example, a distribution medium (not shown), such as a compact disc (CD), or through TX/RX 712.

In alternate embodiments, all or portions of the embodiments may be implemented in hardware, firmware, or combination thereof. Hardware implementations may be in the form of application specific integrated circuit (ASIC), reconfigured reconfigurable circuits (such as Field Programming Field Array (FPGA)), and so forth.

The constitution of these elements 702-714 are known (except for logic and data associated with documents 104, logic 108, case portfolios 110, documents 112, and logic 120), and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method comprising:
receiving by a server, from a plurality of medical-services-related sources, a plurality of medically-related documents of a plurality of heterogeneous document types, the plurality of documents being associated with a medical case; and
selectively organizing the received documents, by the server, into one or more case portfolios for selective distribution to one or more client devices remotely disposed from the server and for corresponding interactive viewing and editing of the documents of the distributed case portfolios on the client device, the organizing including integrating with each of the case portfolios client-side logic for facilitating the interactive viewing and editing on a client device.

2. The method of claim 1, wherein
the plurality of heterogeneous document types includes at least one of medically-related image(s), diagnostic information, patient medical history, findings, pharmacological information, discussion, or annotations, and
the sources include one of a medical device, a computing device, or a removable storage medium.

3. The method of claim 1, wherein the interactive viewing includes a user interaction, and the user interaction is one of a brightness or contrast adjustment to a medically-related image of a distributed case portfolio, navigation between images of a subset of images of the distributed case portfolio, a zooming or panning action on the medically related image of the distributed case portfolio, drawing annotations on the medically-related image of the distributed case portfolio, or saving annotations drawn on the medically-related image of the distributed case portfolio.

4. The method of claim 1, wherein the editing includes at least a selected one of adding to, annotating, or deleting information from a document of a distributed case portfolio.

5. The method of claim 1, wherein said receiving of the documents comprises receiving a presentation file, and said selectively organizing comprises extracting information from the presentation file, and including the extracted information in one or more case portfolios.

6. The method of claim 1, further comprising:
determining, by the server, one or more other case portfolios to be relevant based on comparisons of one or more keywords, tags, or annotations associated with the other case portfolios with the received document; and
automatically including into a case portfolio, by the server, information and/or documents from the determined one or more other case portfolios.

7. The method of claim 1, further comprising automatically performing, by the server, said receiving and said selectively organizing in response to receiving an email from a user including one or more medically-related images and/or text, the one or more medically-related images and/or text comprising the received documents.

8. A method comprising:
providing, by a client device, an interactive element to facilitate a user of a client device in entering medical information to associate with a document of a case portfolio having a plurality of documents of heterogeneous document types;
receiving, by the client device, medical information entered by the user through the interactive element;
in response to said receiving, retrieving, by the client device, one or more medical information suggestions related to the entered medical information based at least in part on the entered medical information and on a medical context associated with the case portfolio; and
manifesting, by the client device, the retrieved one or more medical information suggestions to the user to facilitate the user in selecting at least one of the medical information suggestions to associate with the case portfolio, to complement, augment or expand on the entered medical information.

9. The method of claim 8, wherein the document types include one or more of medical image(s), diagnostic information, patient medical history, findings, pharmacological information, discussion, or annotations.

10. The method of claim 8, wherein the interactive element comprises a text box.

11. The method of claim 8, wherein the entered medical information comprises a truncated partial string of a medical term or phrase.

12. The method of claim 8, wherein the medical context is one of a medical examination type or a pathology type associated with a patient or a medical image referred to in the case portfolio.

13. The method of claim 8, wherein the medical information suggestions are retrieved by searching a knowledge base including one or more of user-defined lists, common vocabularies, folksonomies, or suggestions by other users.

14. The method of claim 8, wherein said retrieving is performed in real time after the user started entering the medical information.

15. A method comprising:
facilitating, by a client device, a user of the client device in meeting medically related certification or continuing education requirements, the facilitating including manifesting to the user one or more case portfolios and tracking a number of case portfolios viewed or an amount of time spent viewing the one or more case portfolios, each of the case portfolio having a plurality of medically related documents; and
providing, by the client device, the user with a report including a plurality of details or metrics, the details/or metrics assembled based at least partially on said tracking.

16. The method of claim 15, wherein the case portfolios each includes a plurality of medically-related documents of a plurality of heterogeneous document types, the document types including one or more of medical image(s), diagnostic information, patient medical history, findings, pharmacological information, discussion, or annotations.

17. The method of claim 15, wherein the tracking comprises turning on a timer when the user begins to view a document of one of the case portfolios and turning the timer off when the user stops viewing documents of the case portfolios.

18. The method of claim 15, further comprising assigning, by the client device, certification or continuing education requirement related credits based on the provided report.

19. The method of claim 15, further comprising enabling the client device to operate in a training mode, the client device performing the facilitating in said training mode, wherein the facilitating under the training mode includes facilitating one or more of quizzes or phased display(s) of the case portfolios.

20. The method of claim 15, wherein the details or metrics include at least one of the number of case portfolios viewed by the user, a number of case portfolios viewed in a training mode, and a total time accumulated while viewing case portfolios.

21. A method comprising:
receiving, by a client device, a case portfolio having a plurality of documents of heterogeneous document types, including medical information, and client-side logic to enable social collaboration; and
facilitating, by the client device, a user of the client device in engaging in a social collaboration associated with the medical information.

22. The method of claim 21, wherein facilitating the user in engaging in the social collaboration comprises facilitating the user in posting a question associated with the medical information.

23. The method of claim 22, further comprising providing the question posting, by the client device, to a server, to enable the server to alert one or more other client devices of the case portfolio and the question posting.

24. The method of claim 21, wherein facilitating the user in engaging in the social collaboration comprises facilitating the user in answering a question posting associated with the medical information or in rating and/or recommending the case portfolio to other users of a community.

25. The method of claim 21, further comprising facilitating, by the client device, the user in providing one or more medical images to a server to enable the server to update the case portfolio with the provided images or to create a new portfolio based on the provided images.
